(19) United States
(12) Patent Application Publication
(10) Pub. No.: US 2026/0242142 A1
(43) Pub. Date: Aug. 20, 2026

(54) ORDER FULFILMENT SYSTEM AND METHOD

(71) Applicant: EXOTEC PRODUCT FRANCE, CROIX (FR)

(72) Inventors: Romain MOULIN, LILLE (FR); Renaud HEITZ, VILLENEUVE D'ASCQ (FR); Marc CHATAIN, ZIMMERBACH (FR); Dimitri DE TONNAC, LEZENNES (FR)

(73) Assignee: EXOTEC PRODUCT FRANCE, CROIX (FR)

(21) Appl. No.: 18/992,612

(22) PCT Filed: Jul. 11, 2023
(86) PCT No.: PCT/FR2023/051073

§ 371 Date: Jan. 9, 2025

(30) Foreign Application Priority Data
Jul. 12, 2022 (FR) 2207156

(51) Int. Cl. B65G 1/137; B65G 1/04; G05B 19/418

(52) U.S. Cl. CPC B65G 1/1378; B65G 1/0492; G05B 19/41895; B65G 2201/0235; B65G 2209/10

(57) ABSTRACT

An order fulfilment system includes: at least one order fulfilment workstation (12₁); a first set of automatically guided vehicles able to roll along the ground and to convey storage containers containing at least one item to the at least one order fulfilment workstation (12₁); and a second set of automatically guided vehicles able to roll along the ground and to convey collecting containers for collecting at least one item to the at least one order fulfilment workstation (12₁). The order fulfilment workstation (12₁) includes an inclined access ramp allowing the vehicle(s) to access the order fulfilment workstation(s) (12₁), including at least: a vehicle-circulation zone (Z1) in which the vehicles circulate, and a vehicle temporary-storage zone (Z2) for temporarily storing the vehicles, a parking zone (Z3) accessible from the inclined ramp and at least two adjacent parking places.

### FIELD

The field of the present disclosure is that of stores or warehouse logistics, and in particular of automating the supply chain logistics.

More specifically, the present disclosure relates to a system and a method for fulfilling at least part of an order.

It notably finds an application in the automation of the management of work streams in a storage warehouse and/or stores, for example in a supply chain logistics order fulfilment warehouse, in the automation of the sorting of the items in a warehouse or stores, or else in the automation of a service that delivers orders to what is commonly referred to as “drive” collection point.

### BACKGROUND

In overall supply chain logistics, workflow management and the handling of the products within a warehouse or stores are key factors.

Traditionally, an order fulfilment operative moves around a warehouse to collect each product on the order inventory from its place on a shelf of a storage rack.

It is found that such organization forces the fulfilment operative to cover long distances over the course of a working day, causing fatigue and wasting time when the path is not optimized.

Another disadvantage is that the fulfilment operative needs to have perfect knowledge of the layout of the warehouse in order not to waste time.

In order to limit fatigue caused by moving around, improve “picking” management, and reduce the time taken to fulfil orders, a warehouse organization known as “product-to-person” has been designed, whereby the products are brought to the order fulfilment operatives by mechanized means.

It is thus known practice to employ conveyors to transport products from a storage zone of a warehouse to an order fulfilment workstation and to transport products from the order fulfilment workstation to a dispatch workstation. It is also known practice to use robots to convey the products from this storage zone to an order fulfilment workstation, the robots being guided by means of circulation rails fitted to the floor of the warehouse.

Patent document US2018/0305123A1 sets out such a technique, whereby robots are guided to the order fulfilment workstation by means of guide rails, or of cogwheel mechanisms, in an order that is determined by a centralized order-inventory management system. Patent document US2019/0270591 sets out a similar technique.

However, this known technique has the disadvantages of being complex and expensive to implement and requires the warehouses to be made large in size, because of the space taken up by the conveyors or the circulation rails.

Moreover, as soon as a storage container is loaded onto a conveyor, or as soon as a robot has started out along a circulation rail or access ramp for accessing the order fulfilment workstation, it is no longer possible to modify the order in which they will arrive at the order fulfilment operative, which means that it is not possible to make impromptu changes to the order in which the order inventory is fulfilled. Specifically, the robots or storage containers have to be presented to the operator in the order in which they started out on the mechanical means that convey them to the order fulfilment workstation. There is therefore no flexibility for allowing the order in which order inventories are fulfilled to be changed as their priority changes: such an order fulfilment method is therefore not flexible.

In order to alleviate these disadvantages, it has been proposed that use be made of mobile robots, and notably of robots of the automated guided vehicle (AGV) type, for picking products from the storage racks and conveying them to an order fulfilment workstation. There has also been the idea of transporting the products from an order inventory and grouped together at an order fulfilment workstation to an order-inventory dispatch workstation using robots. Such robots preferably move autonomously, thereby offering greater flexibility in the organization of the order fulfilment workstations.

Patent document US2021/0221615A1 thus proposes a technique for fulfilling orders using a “rendezvous” fulfilment principle whereby order fulfilment workstations may be set up, on-the-fly, at any point in the warehouse, depending on the requirements and on the volume of orders to be fulfilled.

A disadvantage with this known technique is that the operations of transferring the products from the robots arriving at an order-inventory workstation to the robots intended to convey the products of an order inventory to a dispatch workstation are awkward for an operator to perform: this may cause products to be dropped or knocked, and makes the work of an order fulfilment operative arduous, or even liable to affect their health and, ultimately, cause musculoskeletal problems to arise. Specifically, although such mobile order fulfilment stations offer the advantage of being able to be set up “on-the-fly”, they have the disadvantage of not being very ergonomic.

Furthermore and in general, managing the fleet of robots within a storage shop or stores is a complex operation for which there is a constant desire to improve the efficiency in terms of workflow flexibility, simplicity of operations, and speed of transfer of the products that make up the order inventory and convey them to a dispatch workstation. Operating order fulfilment stations at variable locations introduces additional complexity into the management of the fleet of autonomous mobile robots by increasing the number of possible destinations for these robots, and therefore the routes along which they circulate in the warehouses, as a result complicating the management of the risks of robots colliding with one another. There is therefore still a need for solutions to meet these requirements.

### SUMMARY

The present disclosure meets this need by proposing an order fulfilment system comprising:
at least one order fulfilment workstation;
a first set of automatically guided vehicles able to roll along the ground and to convey storage containers containing at least one item to the order fulfilment workstation(s);
a second set of automatically guided vehicles able to roll along the ground and to convey collecting containers for collecting at least one item to the order fulfilment workstation(s).

Such an order fulfilment workstation comprises:
an inclined access ramp allowing the vehicles to access the order fulfilment workstation(s), comprising at least one vehicle-circulation zone on which the vehicles circulate, and a vehicle vehicles, temporary-storage zone for temporarily storing the
a parking zone accessible from the inclined ramp and comprising at least two adjacent parking places intended to receive a vehicle from the first set and a vehicle from the second set, respectively.

Furthermore, the vehicles are able to roll freely along the inclined ramp in at least two mutually-perpendicular directions in order to move from the circulation zone to any one of either the temporary-storage zone or the parking zone, and vice versa.

Another aspect proposes an order fulfilment method comprising:
conveying at least one storage container containing at least one item, by means of at least one vehicle from a first set of automatically guided vehicles able to roll along the ground, to an order fulfilment workstation;
conveying at least one collecting container for collecting at least one item, by means of at least one vehicle from a second set of automatically guided vehicles able to roll along the ground, to the order fulfilment workstation;
picking at least one item from one of the storage containers and placing the picked item(s) in one of the collecting containers.

According to such a method, the conveying operations are implemented by the movement of the vehicles in a circulation zone formed on an inclined access ramp for accessing the order fulfilment workstation. The picking is performed in a parking zone accessible from the inclined ramp and comprising at least two adjacent parking places intended to receive a vehicle from the first set and a vehicle from the second set, respectively, and, in the event of an order in which to fulfil the order inventories being modified, the method comprises free movement of at least one of the vehicles of the first and/or of the second set of vehicles in at least two mutually-perpendicular directions in order to move from the parking zone or from the circulation zone to a vehicle temporary-storage zone formed on the inclined ramp, and vice versa.

Another aspect proposes a computer program product comprising program code instructions for controlling the movements of vehicles of a first set and of a second set of automatically guided vehicles which are able to roll along the ground according to the method as defined herein when this program is executed by a processor.

Another aspect proposes a non-transient computer-readable recording medium on which such a program is recorded.

Such a recording medium can be any entity or device capable of storing the program. For example, the medium may comprise a storage means such as a ROM, for example a CD-ROM or a microelectronic circuit ROM or else a magnetic recording means, for example a USB drive or a hard disk.

Furthermore, such a recording medium may be a transmittable medium such as an electrical or optical signal, which can be conveyed via an electric or optical cable, by radio or by other means, such that the computer program it contains can be executed remotely. The program according to the invention may in particular be downloaded on a network, for example the Internet.

Alternatively, the recording medium may be an integrated circuit into which the program is incorporated, the circuit being designed to execute, or to be used in the execution of, the aforementioned order fulfilment method.

The features set out in the paragraphs that follow may, optionally, be implemented independently of one another or in combination with one another.

The inclined ramp has a width greater than or equal to the width of four vehicles, preferably greater than or equal to the width of six vehicles.

The vehicle circulation zone comprises at least two vehicle-arrival lanes and at least two vehicle-departure lanes.

The temporary storage zone is substantially horizontal and configured for temporarily storing at least two vehicles.

The parking zone is inclined with respect to the horizontal.

The parking zone has an angle of inclination with respect to the horizontal that is opposite in sign to that of the access ramp.

The temporary storage zone and/or the circulation zone comprise charging means for charging a battery of the vehicles.

The storage containers and the collecting containers belong to the group comprising:
bins;
cardboard boxes.

The adjacent parking places are at different heights.

At least some of the vehicles of the first set of vehicles are also vehicles belonging to the second set of vehicles, or vice versa.

The adjacent parking places are located facing the position of an operator or of a robotic arm.

According to one aspect, the order fulfilment method comprises:
temporary storage of at least one vehicle of the second set in the temporary-storage zone until an order associated with a collecting container being conveyed by the temporarily-stored vehicle becomes the priority;
moving the temporarily-stored vehicle from the temporary-storage zone to the circulation zone in a first direction of movement and moving the temporarily-stored vehicle from the circulation zone to the parking zone in a second direction of movement perpendicular to the first direction of movement.

### BRIEF DESCRIPTION OF THE FIGURES

Further features and advantages of the invention will become more clearly apparent from reading the following description of one embodiment of the invention, given by way of simple non-limiting illustrative example, and from studying the attached drawings, among which:

FIG. 1 is a depiction of an on-line shopping distribution warehouse in which one exemplary embodiment of an order fulfilment method according to the invention is implemented.

FIG. 2 is a detailed perspective view of an order fulfilment workstation of the warehouse presented with reference to FIG. 1.

FIG. 3 is a partial face-on view of the order fulfilment workstation presented with reference to FIG. 2.

FIG. 4 is a partial side view of the order fulfilment workstation presented with reference to FIG. 2.

### DETAILED DESCRIPTION

The general principle of the invention relies on the design of an order fulfilment workstation that autonomous robots access along an inclined ramp and that advantageously has three zones, namely:
a vehicle-circulation zone on which the vehicles circulate;
a vehicle temporary-storage zone in which they may be temporarily stored if the order inventory with which they are associated is not the priority, or needs to be placed “on hold”, or on standby while waiting for items to be restocked, for example;
a parking zone, which comprises at least two adjacent places intended to receive a robot carrying a storage container from the item storage warehouse, and a robot carrying a collecting container intended to receive the inventory items on an order in the process of being fulfilled, respectively.

Such robots are autonomous in their movement and may notably move in 2D on the inclined ramp, and circulate freely between the three, circulation, temporary-storage and parking, zones, depending on the level of priority of the order with which they are associated.

It is thus very easy to modify the order in which the orders are fulfilled by sending a robot, which has started out along the circulation zone or is already present in the parking zone, a command to move aside to the temporary-storage zone where it remains temporarily on hold. Conversely, as soon as the processing of the order with which it is associated regains the priority status, or as soon as missing inventory items have been conveyed to the order fulfilment workstation, the robot can easily exit the temporary-storage zone and return to the circulation zone or return directly to the parking zone. This then provides a great deal of fluidity in order fulfilment which can begin, be temporarily interrupted in order to slot-in the processing of another order at the order fulfilment workstation, and be resumed quickly, through a simple, quick and small movement of the robots within the three, circulation, parking and temporary-storage, zones provided.

The fact that there is a temporary-storage zone at the order fulfilment workstation advantageously enables some of the inventory items on an order that is in the process of being fulfilled to be stored temporarily, for example while awaiting the restocking of an inventory item that has been ordered but that is missing from the warehouse or stores, or when the dispatch of the order needs to be deferred.

Furthermore, such an order fulfilment workstation is particularly ergonomic: it has at least two adjacent places facing the operator or facing a robotic arm and, preferably, within reach of same, to receive one or more storage container(s) and one or more collecting container(s) that respectively store/collect the inventory items on the order that is being fulfilled. Thus, the operator does not need to walk around or move the motorized arm on the ground in order to be able to transfer the inventory items on an order between the storage containers and the collecting containers. This transfer is performed in a simple and ergonomic movement of the operator's arm or of the robotic arm, in a shortened space of time.

Furthermore, these adjacent places, accessible from the inclined access ramp for accessing the order fulfilment workstation, are preferably positioned at the correct height for a person, so that the operator does not have to bend down in order to handle the inventory items on the order. This then reduces the magnitude of the movements that the operator has to perform, and therefore the risks of the onset of musculoskeletal problems.

The presence, in the parking zone, of a number of adjacent places greater than two also makes it possible to reduce the time taken to fulfil the orders. This is because it is possible to position in the parking zone several storage containers transporting different items required to fulfil the order (for example, one container of table tennis balls and one container of table tennis racquets). The table tennis balls are picked from the first container and placed in the collecting container, then the table tennis racquets are immediately picked from the second container, without the need to wait for the table tennis racquet container to have taken the place of the balls container in the parking place dedicated to the storage containers. It is also possible to have several collecting containers in the parking zone, and this is advantageous when the same inventory item is required for fulfilling a number of orders. For example, if three customers have ordered table tennis balls, three collecting containers may be placed in the parking zone, together with the storage container containing the table tennis balls. It is then possible to pick table tennis balls from the storage container and place them successively and quickly in each of the three collecting containers.

Thus, the design of such an access ramp has the combined technical effect of making the order fulfilment workstation highly ergonomic and of providing flexibility in the organization of the order in which orders are fulfilled, thereby making it possible substantially to reduce order fulfilment times and optimize the efficiency of the process of handling multiple orders.

One exemplary embodiment of an order fulfilment system and of the associated order fulfilment method will now be described in connection with the figures.

Throughout this document what is meant by the term vehicle or robot is any motorized vehicle equipped with at least two wheels for rolling along the ground (and which may therefore have two, three, four or even a greater number of rolling wheels) and which is intended to transport a load, with the exception of any flying object. The terms robots and vehicles are used interchangeably. Examples of such vehicles are described for example in patent documents WO2023001449 and FR3125514 in the name of the Applicant.

As a preference, such robots or vehicles are autonomous in their movement, and capable of changing course very quickly, in a small footprint. For example, such robots or vehicles are equipped with a drive wheel mounted on a vertical axis: when the drive wheel is rotated about this vertical axis, this wheel pivots just enough to change the direction of rolling, without turning the chassis of the robot, which is thus able to change direction of circulation almost on the spot.

In one embodiment, such robots move not only in 2D along the ground, but are also able to move in 3D, pressing against the racking of the warehouse to move up height-wise along this racking to fetch a storage container or a collecting container that is stored there.

The term “container” refers to any device able to be transported by a robot and to contain one or more items, objects or products. In what follows, the term “container” may refer indiscriminately to a bin, a basket, a case, a crate, a cardboard box, etc.

Moreover, the terms “items” and “products” may be interchanged with one another. They simply refer to an object, notably a commercially available object, stored in a workshop, stores or a warehouse, intended to be delivered to an end-customer who has ordered it, on its own, or in conjunction with one or more other items.

Finally, the temporary-storage zone may be a zone intended for storing orders that are waiting to be delivered in a “drive”, without departing from the scope of the present disclosure.

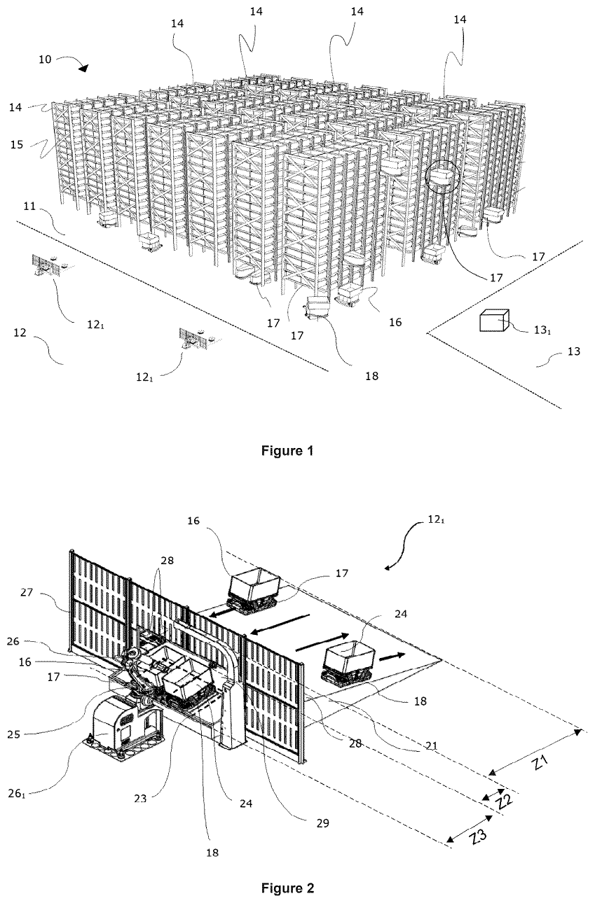

FIG. 1 illustrates an automated distribution warehouse 10 of an on-line shopping company. This warehouse is organized into three areas: a storage area 11, an order fulfilment area 12 equipped with order fulfilment workstations 12₁, and a dispatch area 13 equipped with a packaging and package-dispatch workstation 13₁.

The storage area 11 comprises a plurality of racking units 14 formed of shelves on multiple levels that are supported by uprights 15 and organized in successive parallel rows. Storage containers 16 which may contain items that are all similar or a plurality of different items from the same product range are stored on these shelves. Moreover, it will be noted that some of this racking is reserved for the storage of collecting containers intended to collect the various items that make up an order inventory, before conveying them to the dispatch workstation 13₁.

A first fleet of automatically guided vehicles 17, equipped for example with four wheels for rolling along the ground, transports the storage containers 16 between the storage area 11 and the order fulfilment workstations 12₁.

When a robot 17 receives instructions to fetch a bin 16 from a racking unit, the robot 17 rolls along the ground to the base of the racking unit 14 on which this bin 16 is stored, and climbs up along this racking unit, pressing against the racking unit opposite it, until it reaches the level of the shelf on which this bin 16 is stored, and collects it. The vehicle 17 then moves back down between the two racking units and, once it has reached the ground, transports the bin 16 to the order fulfilment workstation 12₁.

This first set 17 therefore groups together a first set of automatically guided vehicles able to roll along the ground and intended to pick storage containers storing one or more item(s) stored in the racking and transport them to the order fulfilment workstation.

A second fleet of automatically guided vehicles 18 transports collecting containers:
on the one hand, when empty, from the racking units 14 to the order fulfilment workstations 12₁;
and on the other hand, when they have collected one or more items from the one same order, which items have previously been picked from the storage bins 16 conveyed to the order fulfilment workstation 12₁, from the latter to the dispatch workstation 13₁.

This second set 18 therefore groups together a second set of automatically guided vehicles able to roll along the ground and intended to transport collecting containers containing at least some of the inventory items on the one same order from an order fulfilment workstation 12₁ to an order-dispatch workstation 13₁, to a temporary-storage zone, or to a conveyor connected to an order dispatch workstation.

Provision may be made for a robot 17 or 18 to be used both for transporting storage bins 16 to an order fulfilment workstation 12₁ and, intermittently, for transporting collecting bins to the dispatch workstation 13₁, or vice versa, depending on how the requirements and availability of the other robots of these fleets evolve at any given moment.

This offers a great deal of flexibility in the management of the fleet of vehicles, since the one same vehicle can be used alternatively for transporting storage containers or collecting containers, and therefore form part of the first or of the second set of vehicles, as need be. Thus, at least some of the vehicles of the first set of vehicles are also vehicles belonging to the second set of vehicles, or vice versa, making it possible to reduce the total number of vehicles to be employed for transporting the storage containers and the collecting containers.

The second set of vehicles may be a subset of the first set of vehicles, or vice versa.

At the start of the fulfilment of order or an of a part-order:
a collecting container is assigned thereto and its identification is recorded in a centralized management system, in association with an order number;
a vehicle from the second set 18 picks this collecting container from the racking;
this vehicle 18 transports the picked collecting container to an order fulfilment workstation 12₁ where it is positioned on a first parking place that faces the position of an operator or of a robotic arm.

Likewise, a storage container containing at least one inventory item on the order or on the part-order is assigned to a vehicle of the first set 17, by recording an identification of the vehicle and an identification of the storage container in association with one another in a centralized management system. The vehicle 17 picks the storage container assigned to it from the racking and conveys it to a second parking place of the order fulfilment workstation 12₁, which parking place is adjacent to the first place which has been taken up by the collecting container, and which likewise faces the position of an operator or of a robotic arm.

The operator or the robotic arm can then pick one or more inventory items on the order from the storage container that has taken up its place in the second parking place and then place it (them) in the collecting container that has taken up its place in the first parking place adjacent to it.

If all of the inventory items on the order have been placed in the collecting container, the latter can be transported by the vehicle 18 to a dispatch workstation or on a conveyor leading to this dispatch workstation, or to a box-sealing device if the collecting container in which the order is to be dispatched is a cardboard box.

Such an order fulfilment technique advantageously allows several orders, made up of inventory items stored at different storage locations in the workshop, stores or warehouse, to be fulfilled concomitantly in a reduced space of time, as will be better appreciated from reading the description of FIGS. 2 to 4 below.

FIG. 2 depicts in detail an order fulfilment workstation 12₁, shown in a perspective profile view.

This order fulfilment workstation 12₁ is equipped with a robotic arm 26 known per se, which could also be replaced by a human operator. The base 26₁ of the robotic arm is fixed or rotates about an axis that is fixed with respect to the ground.

The storage containers 16 are conveyed to this order fulfilment workstation 12₁ by vehicles 17 of the first set of automatically guided vehicles which enter an inclined access ramp 21, for example from the left side. The vehicles 18 of the second set of automatically guided vehicles leave the inclined access ramp 21 from its right side, in this particular embodiment of the invention. In this example, the access ramp 21 is an up-ramp that allows the robots 17, 18 that are moving around by rolling along the floor of the warehouse from the storage area 11 to the order fulfilment area 12 to move upwards to the order fulfilment workstation 12₁. In another example in which the robots run around at a higher level in the warehouse, the inclined access ramp 21 could equally allow the robot to descend, from this upper level, down to the order fulfilment workstation 12₁.

As may be seen in greater detail in FIG. 4, which is a side view of the order fulfilment workstation 12₁ illustrated in FIG. 2, the inclined access ramp 21 comprises two distinct zones:
a zone, referenced Z1, in which the vehicles circulate;
a zone, referenced Z2, for temporarily storing the vehicles.

The temporary-storage zone Z2 is substantially horizontal and allows at least two vehicles, for example a vehicle from the first set 17 and a vehicle from the second set 18, to be stored temporarily. It may also be dimensioned to allow simultaneous storage of a greater number of vehicles, as need be.

This zone Z2 may comprise means for charging a battery of the vehicles 17, 18 while they are temporarily stationary in the zone Z2. This may for example be induction-charging modules, also known as “pads”, that enable the batteries of the vehicles to be charged when the vehicles are parked on the ramp. This then saves time and space because there is no need to provide additional charging stations, or at the very least the capacity and/or number of such other charging stations can be reduced. These charging means may also be positioned in the circulation zone Z1. For example, charging pads 28 are provided on each of the edges of the ramp 21, to recharge the batteries of the robots 17 or 18.

The vehicle circulation zone Z1 comprises at least two vehicle-arrival lanes and at least two vehicle-departure lanes, indicated symbolically by arrows in FIG. 2, to allow great fluidity in the movement of the vehicles 17, 18 and therefore allow simultaneous management of the fulfilment of several orders. For example, the inclined ramp 21 has a width greater than or equal to the width of four vehicles, preferably greater than or equal to the width of six vehicles, so as to allow multiple crossovers and allow vehicles 17, 18 to ascend and descend the access ramp 21 simultaneously. Thus, a vehicle 17 transporting a first storage container and a vehicle 18 transporting a first collecting container may simultaneously ascend the access ramp 21 in order to access the order fulfilment workstation, where the fulfilment of the order with which they are associated commences, while a vehicle 17 transporting a second storage container and a vehicle 18 transporting a second collecting container descend this ramp simultaneously because the fulfilment of the order with which they are associated has finished.

The order fulfilment workstation also comprises a parking zone referenced Z3, that the vehicles 17, 18 access from the inclined ramp 21. The upper end of the ramp 21 is surmounted by a fence 27 separating the parking zone Z3 from the vehicle-circulation zone Z1 and vehicle temporary-storage zone Z2 for the vehicles 17 and 18. Moreover an opening 29 is formed in this fence to allow the vehicles 17 and 18 to access the parking places of this parking zone Z3, within reach of the robotic arm 26. The exemplary embodiment of FIGS. 2 to 4 depicts a parking zone Z3 comprising exactly two parking places, and the opening 29 is therefore dimensioned to allow two vehicles to pass through simultaneously. However, the parking zone may comprise a greater number of parking places, for example four or six, depending on the width of the ramp 21. In that case, the opening 29 in the fence 27 is of course tailored to allow four or six vehicles, depending on the number of parking places, to pass through simultaneously.

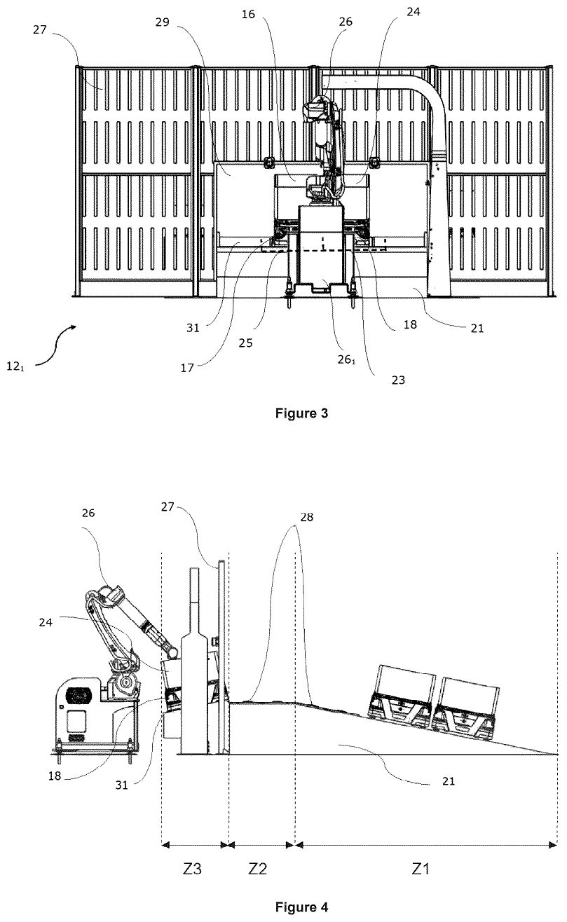

The robotic arm 26, mounted on a fixed base 26₁, is intended to pick an item from a storage container 16 conveyed by a vehicle 17 in a predetermined parking place 25 (indicated in dotted line in FIG. 2 and in FIG. 3 which is a face-on view of the order fulfilment workstation 12₁) at the end of the ramp 21 and place it in an item collecting bin 24 transported by a vehicle 18 in a predetermined parking place 23 (indicated in dotted line in FIGS. 2 and 3) at the end of the ramp 21. Because the first parking place 25 and the second parking place 23 for the robots are advantageously adjacent and face the robotic arm 26, the movements of the arm 26, for each item handled, are restricted to: picking an item from the storage bin 16, rotating the arm to position the arm over the collecting bin 24, placing the item in the collecting bin 24 in a substantially vertical movement, and returning to its initial position, which means that these operations can be repeated at a fast pace. The same is true in a configuration having three, four or six adjacent parking places, except that the amplitude of the movement of the arm is then greater.

It will moreover be readily appreciated that, in variants of this embodiment in which the operations performed by the robotic arm are performed by an operator, aside from the timesaving that this arrangement provides, the risks of the operator developing musculoskeletal problems and the risks of items falling on the floor if they escape the grasp of the operator are greatly reduced.

The first parking place 25 and the second parking place 23 are formed of two substantially adjacent planar surfaces which constitute the parking zone Z3 that forms a portion extending the upper part of the ramp 21. In a configuration involving four or six parking places, the zone Z3 takes the form of an inclined planar surface extending the upper part of the ramp and the width of which corresponds substantially to the width of four or six vehicles, according to the number of parking places.

The items to be picked may thus easily be placed at the correct height for an operator, thus likewise making them easier to place in the collecting containers.

It may also be seen in FIG. 4 that the parking zone referenced Z3 is inclined with respect to the horizontal. When the inclined access ramp 21 is an up-ramp, this parking zone Z3 notably has an angle of inclination with respect to the horizontal that is opposite in sign to that of the access ramp 21. Thus, the respective parking places 23 and 25 for the robots 18 and 17 are on an inclined plane 31, making it easier for the robotic arm 26 to access the items in the storage containers 16 and place them in the collecting containers 24.

In order to improve the ergonomics of the order fulfilment workstation still further, provision may be made for the respective parking places 23 and 25 for the robots 18 and 17 to be adjustable in terms of height or to be at different heights, in order to suit the dimensions of the storage and collecting containers. Thus, the height of the upper opening of the storage containers and of the upper opening of the collecting containers can be adapted independently, for example in order to position these openings substantially at the same level if the storage containers and the collecting containers have different height dimensions. This is particularly advantageous in the case of the parking place intended to receive the collecting container, in instances in which this collecting container is directly the cardboard box in which the order is to be dispatched, as it will be readily appreciated that the dimensions of this may vary from one order to another, depending on the number of items ordered by the customer, or the size of these items. In instances in which a number of orders are being fulfilled in parallel, and a number of dispatch boxes are therefore stationed in adjacent places of the parking zone, the height of the parking place can thus be adjusted individually for each of the collecting boxes, according to the dimensions thereof, which dimensions will have been chosen according to the volume of items ordered.

By making it possible to adjust the height of the parking place for the collecting box according to the height of this box, it is possible to ensure that the upper opening of the box is always positioned at the correct level for the operator or the robotic arm, so as to improve the ergonomics of the order fulfilment workstation. Such height adjustment may be achieved by means of an adjusting rack, or using motorized lifting means, which can be controlled by the centralized management system, according to the dimensions of the collecting box selected from the racking. These dimensions are known to the centralized management system, from the identification of the collecting box that has been associated with the identification of the order that is in the process of being fulfilled.

As will be appreciated by studying FIGS. 2 to 4, it is thus possible to begin to fulfil a first order at the order fulfilment workstation 12₁, using a first collecting container brought by a vehicle 18 of the second set, while asking an operator or a robotic arm 26 to place therein some of the items from the first order, these items, contained in different storage containers, having been transported beforehand to the order fulfilment workstation 12₁ by a plurality of vehicles from the first set 17 of vehicles.

In the event that fulfilling a second order now takes priority, or if it is not possible to complete the fulfilment of the first order because an inventory item on this first order is missing, the vehicle of the second set 18 gives up its position in the first parking place 23 to another vehicle of the second set 18 bearing a second collecting container for fulfilling a second order, and transports the first collecting container in which some of the items from the first order have been placed to the temporary-storage zone Z2 where it is placed on hold awaiting completion of the first order.

Fulfilment of the second order may then begin, with the operator or the robotic arm being asked to place items from the second order and contained in storage containers brought to the order fulfilment workstation 12₁ by vehicles of the first set 17 into the second collecting container. Once all or some of the items from the second order have been placed in the second collecting container, the latter may be sent to the temporary-storage zone Z2 (if fulfilment of this second order is incomplete, for example because an item is missing), to a dispatch workstation (if fulfilment of this second order is complete) or to a conveyor connected to a dispatch workstation.

In summary, there are at least three conceivable modes of operation for fulfilling an order using the system of FIGS. 2 to 4:

### Example 1: Fulfilment of a “Simple” Order with an Inventory of Just One Item

Having associated a vehicle of the first set 17 with the storage container containing the single inventory item on the order, this vehicle transports the storage container to the order fulfilment workstation 12₁: it circulates, via the circulation zone Z1 of the access ramp 21, to the parking zone Z3 in which it parks in the second predetermined parking place 25. The operator or a robotic arm 26 picks the item and places it in a collecting container situated in the first predetermined parking place 23. This collecting container has been transported by a vehicle of the second set 18 of vehicles, through the circulation zone Z1, to the parking zone Z3. The collecting container may then be transferred to a temporary-storage area (for example while awaiting “drive” pickup of the order by the end-customer) or to a dispatch workstation.

If a plurality of “simple” orders for a plurality of customers are made up of the one same inventory item, a plurality of collecting containers may also be positioned on a plurality of adjacent places in the parking zone Z3, together with the storage container containing the single inventory item ordered. The operator or the robotic arm picks the item and places it in each of the collecting containers in succession, which containers can then be transferred to a temporary-storage area or to a dispatch workstation.

### Example 2: Fulfilment of a “Simple” Order with an Inventory of Several Different Inventory Items Stored at Different Locations in a Warehouse

The procedure for fulfilling the order is substantially similar to that of Example 1. Because the order inventory consists of a number of inventory items, a number of vehicles from the first set 17 are made to go and pick the storage containers each containing one of the inventory items on the order, after each having been associated with one of the storage containers to be picked, and to bring these one after another to the second predetermined parking place 25. An operator or a robotic arm 26 then successively picks the various inventory items on the order and places them in a collecting container situated in the first predetermined parking place 23 and brought there by a vehicle of the second set 18 of vehicles.

Thus, if the parking zone has two parking places 23 and 25, a first vehicle 17 conveying a first storage container containing a first inventory item on the order ascends the access ramp 21 via the circulation zone Z1 and accesses the parking zone Z3. The first inventory item is picked by the robotic arm 26 and placed in the collecting container situated on the place 23 directly adjacent to the parking place 25 occupied by this first vehicle 17. This first vehicle can then immediately descend the inclined ramp 21 again via the same lane of the circulation zone Z1 that it used for ascending the ramp, or via another down-lane of this circulation zone Z1. The vehicle can easily switch from one lane to the other by performing a movement in a direction perpendicular to the direction of these circulation lanes, for example by rotating its drive wheel on the spot. While this first vehicle is descending the ramp 21, a second vehicle 17 conveying a second storage container containing a second inventory item on the order ascends the access ramp 21 via a free circulation lane of the access ramp 21. The ascent and the descent of the two vehicles may occur simultaneously, thereby affording a substantial time-saving in the fulfilment of the order. When it reaches the top of the ramp 21, if the up-lane that it used is not facing the parking zone, the second vehicle 17 may move in a direction perpendicular to its direction of ascent, until it is facing its parking place. It then pivots again through 90° in order to advance as far as its parking place, in a direction parallel to the direction in which it ascended the ramp 21.

Once again, the robotic arm 26 picks the second inventory item on the order from the storage container parked in the parking place 25 and places it in the collecting container parked in the adjacent parking place 23. The second vehicle 17 may then leave the parking zone Z3 to return, via the circulation zone Z1, to the storage area 11 where it will return the storage container to the racking 14. It may also leave the parking zone Z3 to head towards another order fulfilment workstation at which the items that it contains are required for fulfilling another order. Finally, it may leave the parking zone Z3 and park temporarily in the temporary-storage zone Z2, in the event that the items that it contains may be used to fulfil another order expected to be fulfilled in the near future at this same order fulfilment workstation 12₁. Specifically, in that case, it is advantageous for the vehicle to remain at the order fulfilment workstation in order to avoid any needless movement and therefore reduce the time taken to process the order. It is thus beneficial for the temporary-storage zone Z2 to be able to store several vehicles, if all of these may be of use in fulfilling an upcoming order.

When order fulfilment is complete because all of the inventory items on the order have been collected, the collecting container associated with that order can be transferred to a temporary-storage area or to a dispatch workstation.

If, on the other hand, the parking zone Z3 has more than two parking places, it is possible for a collecting container transported by a vehicle 18 and various storage containers transported by vehicles 17 of the first set and each containing an inventory item on the order to be parked simultaneously in this zone. This then further speeds up the time taken to process the order because the various inventory items can be picked quickly and successively by the robotic arm from each of the storage containers and placed in the collecting container. As soon as an item has been picked from a storage container by the robotic arm, the vehicle that is transporting it may leave the ramp and give up its place to another vehicle.

### Example 3: Fulfilment of Part of an Order with an Inventory of Several Inventory Items with this Order being Put on Hold in Order to Fulfil Another Order which has in the Meantime Become the Priority

In this example, the fulfilment of an order C1 is begun according to the procedure of Example 2. If another order C2 becomes the priority, the transfer of inventory items on the order C1 that is in the process of being fulfilled in the collecting container in the parking zone Z3 is paused, and this collecting container on the vehicle of the second set 18 that is carrying it is moved to the temporary-storage zone Z2. This frees up the first predetermined parking place 23 for a vehicle of the second set 18 carrying the collecting container associated with the order C2 that has become the priority, and fulfilment of the order C2 that has become the priority may commence with storage containers containing inventory items on the order C2 being transported using vehicles of the first set 17 of vehicles to the second parking place 25.

Thus, the vehicle 18 associated with the order C1 parks temporarily in the temporary-storage zone Z2. During this time, the vehicles 17 conveying the storage containers containing inventory items on the order C2 circulate via the circulation zone Z1 and successively access the parking zone Z3. When the robotic arm 26 has picked an inventory item on the order C2 from one of these vehicles 17, said vehicle can leave the ramp 21 via the circulation zone Z1, while the next vehicle 17 ascends, in parallel, via another access lane of the ramp. When the fulfilment of the order C2 is complete, the vehicle 18 associated with the order C1 leaves the temporary-storage zone Z2 to return to the parking zone Z3, where fulfilment of the order C1 may resume. The vehicles may switch from one access lane to another, or from the circulation zone to the temporary-storage zone, or else from the temporary-storage zone to the parking zone, by moving in at least two mutually-perpendicular directions, namely a direction parallel to the access lanes and a direction perpendicular to the access lanes.

The above examples of modes of operation in no way limit the approach taken to the management of the vehicles, the inventory items and the orders when implementing the method of the present invention. They simply seek to illustrate the flexibility offered by said method as regards the management of the vehicles and as regards the fulfilment of the order inventories.

Specifically, structuring the order fulfilment workstation as three zones, configuring the inclined access ramp to have several up-lanes and down-lanes for the vehicles, combined with the very great mobility that the vehicles have in how they move, allow greater flexibility in the management of the order in which orders are fulfilled, placed on hold, and returned to, according to how their level of priority evolves.

In order to limit the amount of time lost to conveying the various storage containers used for making up an order inventory to the second parking place 25, the robots 17 advantageously queue in line one behind the other on the ramp 21 while waiting for a space in one of the parking places 25 to become free by being given up by the vehicle before them, after the inventory item(s) on the order have been picked from the storage container supported by that vehicle by the robotic arm 26 which vehicle then moves away to the side to descend the ramp via a down-lane parallel to the up-lane.

### LIST OF CITED DOCUMENTS

### Patent Documents

For reference, the following patent documents have been cited:

patcit1: US2018/0305123A1 (publication number);
patcit2: US2019/0270591 (publication number);
patcit3: US2021/0221615A1 (publication number);
patcit4: WO2023001449A1 (publication number);
patcit5: FR3125514A1 (publication number).

1.-15. (canceled)

16. An order fulfilment system comprising:
a. at least one order fulfilment workstation;
b. a first set of automatically guided vehicles able to roll along the ground and to convey storage containers containing at least one item to said at least one order fulfilment workstation;
c. a second set of automatically guided vehicles able to roll along the ground and to convey collecting containers for collecting at least one item to said at least one order fulfilment workstation;
said at least one order fulfilment workstation comprises:
i. an inclined access ramp allowing said vehicles to access said at least one order fulfilment workstation, comprising at least:
a vehicle-circulation zone in which said vehicles circulate, and
a vehicle temporary-storage zone for temporarily storing said vehicles,
ii. a parking zone, accessible from said inclined ramp and comprising at least two adjacent parking places which are intended to receive a vehicle from said first set and a vehicle from said second set, respectively,
said vehicles are able to roll freely along said inclined ramp in at least two mutually-perpendicular directions in order to move from said circulation zone to any one of either said temporary-storage zone or said parking zone, and vice versa.

17. The order fulfilment system according to claim 16, wherein said inclined ramp has a width greater than or equal to the width of four vehicles, preferably greater than or equal to the width of six vehicles.

18. The order fulfilment system according to claim 17, wherein said vehicle-circulation zone comprises at least two vehicle-arrival lanes and at least two vehicle-departure lanes.

19. The order fulfilment system according to claim 16, wherein said temporary-storage zone is substantially horizontal and configured for temporarily storing at least two vehicles.

20. The order fulfilment system according to claim 16, wherein said parking zone is inclined with respect to the horizontal.

21. The order fulfilment system according to claim 20, wherein said parking zone has an angle of inclination with respect to the horizontal that is opposite in sign to that of said access ramp.

22. The order fulfilment system according to claim 16, wherein said temporary-storage zone and/or said circulation zone comprise charging means for charging a battery of said vehicles.

23. The order fulfilment system according to claim 16, wherein said storage containers and said collecting containers belong to the group comprising:
bins;
cardboard boxes.

24. The order fulfilment system according to claim 16, wherein said at least two adjacent parking places are at different heights.

25. The order fulfilment system according to claim 16, wherein at least some of the vehicles of said first set of vehicles are also vehicles belonging to said second set of vehicles, or vice versa.

26. The order fulfilment system according to claim 16, wherein said at least two adjacent parking places are located facing the position of an operator or of a robotic arm.

27. An order fulfilment method comprising:
i. conveying at least one storage container containing at least one item, by means of at least one vehicle from a first set of automatically guided vehicles able to roll along the ground, to an order fulfilment workstation;
ii. conveying at least one collecting container for collecting at least one item, by means of at least one vehicle from a second set of automatically guided vehicles able to roll along the ground, to said order fulfilment workstation;
iii. picking at least one item from one of said storage containers and placing said at least one picked item in one of said collecting containers;
said conveying operations are implemented by the movement of said vehicles in a circulation zone formed on an inclined access ramp for accessing said order fulfilment workstation, said picking is performed in a parking zone accessible from said inclined ramp and comprising at least two adjacent parking places intended to receive a vehicle from said first set and a vehicle from said second set, respectively,
wherein in the event of an order in which to fulfil the order inventories being modified, said method comprises free movement of at least one of said vehicles of the first and/or of the second set of vehicles in at least two mutually-perpendicular directions in order to move from said parking zone or from said circulation zone to a vehicle temporary-storage zone formed on said inclined ramp, and vice versa.

28. The order fulfilment method according to claim 27, further comprising:
temporary storage of at least one vehicle of said second set in said temporary-storage zone until an order associated with a collecting container being conveyed by said temporarily-stored vehicle becomes the priority;
moving said temporarily-stored vehicle from said temporary-storage zone to said circulation zone in a first direction of movement and moving said temporarily-stored vehicle from said circulation zone to said parking zone in a second direction of movement perpendicular to said first direction of movement.

29. A computer program product comprising program code instructions for controlling the movements of vehicles of a first set and of a second set of automatically guided vehicles which are able to roll along the ground according to the method of claim 27 when this program is executed by a processor.

30. A non-transient computer-readable recording medium on which there is recorded a program for controlling the movements of vehicles of a first set and of a second set of automatically guided vehicles which are able to roll along the ground according to the method of claim 27 when this program is executed by a processor.
